(19) United States
(12) Patent Application Publication
(10) Pub. No.: US 2024/0180071 A1
(43) Pub. Date: Jun. 6, 2024

(54) Autonomous Mowers With Hazard Avoidance

(71) Applicant: Embankscape Equipment LLC, Suamico, WI (US)

(72) Inventors: Matthew D. Bries, Green Bay, WI (US); Raymond F. Watkins, Suamico, WI (US)

(73) Assignee: Embankscape Equipment LLC, Suamico, WI (US)

(21) Appl. No.: 18/074,383

(22) Filed: Dec. 2, 2022

(51) Int. Cl. A01D 34/00; G01S 19/13; G05D 1/02

(52) U.S. Cl. CPC A01D 34/008; G01S 19/13; G05D 1/0274; G05D 1/0278; G05D 1/0289; A01D 2101/00

(57) ABSTRACT

Robotic, autonomous mowers are programmed and configured to avoid collisions with each other. Each mower may include a transceiver allowing direct machine-to-machine digital communication with other mowers over a wireless data channel. Each mower may periodically transmit a digital data packet that may include navigational information and/or a priority code such as a machine serial number. Detection of such a data packet may be used to alert a mower to the presence of another mower nearby. The navigational information may include a stored mow path map or mow path timetable showing the mower's current location and the path the mower is programmed to follow in the coming seconds or minutes. Comparison of a mower's own mow path map with that received from the other mower may be used to declare a hazard condition. Comparison of the priority codes may be used to determine which mower is to take evasive action.

### FIELD OF THE INVENTION

The present invention relates to machines and systems for mowing grass, weeds, brush, and the like, with particular focus on such systems in which the mower is autonomous, i.e., it carries out its mowing operation under its own control rather than under the control of a human operator. The invention also pertains to related methods, systems, and articles.

### BACKGROUND OF THE INVENTION

Numerous types of residential, commercial, and industrial mowing machines and systems are known. The vast majority of such machines are configured for only manual control by a single user who pushes or sits atop a mower unit. For riding mowers, so-called zero-turn mowers are quite popular. Such mowers are equipped with separate left-wheel and right-wheel control handles (lap bars) by which the rider can move the mower forward, reverse, and through a range of turns including forward turns, backward turns, and zero-turns, i.e., turns whose turn radius is essentially zero.

Other mowers are configured for real-time remote control operation by a human operator. See for example U.S. Pat. No. 11,234,362 (Brandt). Still other mowers are configured as fully autonomous robotic machines that perform mowing operations while under the control of a microprocessor or similar digital controller rather than any human operator.

### SUMMARY OF THE INVENTION

From our knowledge and observations of existing autonomous mowers, we have identified certain problems, deficiencies, or limitations associated with them, and have developed improvements to their design and operation to provide new families of autonomous mowers and mower systems. Some or all of these improvements relate to enhancing the safe operation of autonomous mowers. The various improvements disclosed herein can be used individually or in any combination for a given autonomous mower.

Some of the improvements relate to avoiding or otherwise dealing with hazardous situations that can arise when two or more autonomous mowers operate in the same vicinity. For example, the mowers may collide with each other or may have a near-collision, or they may get into a standoff situation where each mower waits for the other mower to move out of the way.

Some improvements relate to configuring the mowers to communicate with each other, whether directly over a dedicated machine-to-machine wireless data channel, or otherwise. Such mower-to-mower communication can be used to exchange data that, if acted on appropriately by an on-board electronic controller, can be used to avoid hazardous situations. The data to be exchanged may be specific to each mower and may be stored in an electronic memory unit of the respective mower.

In some cases the data may be or may include a machine serial number or other digital code that can be used as a priority code in case of an encounter between two autonomous mowers. The digital code for a given mower should not be the same as the corresponding code for any other mower it could potentially encounter, which is why a machine serial number can be conveniently and easily used for this purpose. When a first mower receives the digital code from a second mower over the wireless data channel, it may compare the received digital code with the first mower's own digital code and then take action, or not, based on the comparison. The second mower may likewise receive the digital code from the first mower and make its own comparison and take its own action or inaction using the same or similar logic used by the first mower. For example, each mower may be programmed to designate itself as either “junior” or “senior” based on the comparison, and may further be programmed to pause its operation if and when it is designated junior, but to maintain its operation if it is designated senior (or, more simply, if it does not designate itself as junior). A first mower may for example designate itself “junior” if its own machine serial number is greater or more recent than the machine serial number of the second mower, or vice versa.

In some cases, the data may be or include a mow path map and/or a mow path timetable. A mow path map is a data set that includes information setting forth, among other things, the specific route a given mower is programmed to follow in the near future, e.g., for a period starting now and extending for at least 5, 10, or 20 seconds. A mow path timetable is a data set that includes a mow path map but also includes timing information about when the given mower is programmed to be located at certain specific locations within the mow path map. When a first mower receives a second mower's mow path map or mow path timetable over the wireless data channel, it may compare the received mow path map/timetable with its own such map/timetable and then take action, or not, based on the comparison. The comparison may involve calculating distances between points on the received mow path map/timetable and points on its own mow path map/timetable. If none of the calculated distances are less than a predefined threshold safe separation distance, the first mower may maintain its operation without any interruption or delay. If however any of the distances are less than the predefined threshold, the mower may be programmed to declare the existence of a hazard condition and take appropriate evasive action, or it may first further analyze the received data based on timing information to determine if some of the calculated distances, though less than the threshold separation, are not suitable for declaring a hazard condition due to sufficiently large time differentials.

The disclosed capabilities of an automated mower to broadcast its own digital navigation information or other digital information to other such mowers, and to receive corresponding information from such other mowers, may have more general applicability in addition to or instead of their applicability in predicting and/or resolving potentially hazardous situations between mowers.

We disclose, among other things, methods of operating a first autonomous mower that include: providing the first mower with a drive system, a controller, a memory unit, and a wireless transceiver; storing a first mow path map and a first priority code in the memory unit; maneuvering the first mower, using the drive system under control of the controller, along a first mow path in accordance with the first mow path map; generating a first mow path timetable from the first mow path map to indicate when the first mower will be at different points along the first mow path map; transmitting from the transceiver a first data packet that includes the first mow path timetable and the first priority code; and monitoring for the presence of a second mower during the maneuvering. If the second mower is present, the method may further include: receiving from the second mower, via the transceiver, a second data packet that includes a second mow path timetable and a second priority code; determining, using the first and second mow path timetables, whether a hazard condition exists; comparing the first priority code to the second priority code; and upon determining that the hazard condition exists, determining whether to modify the maneuvering as a result of the comparing.

The determining whether a hazard condition exists may include calculating separation distances using the first and second mow path timetables. The determining whether a hazard condition exists may also include comparing the calculated separation distances to a first separation threshold. The result of the comparing may be to designate the first mower with one of a junior status or a senior status, and the determining whether to modify the maneuvering may yield a determination to modify the maneuvering only if the first mower designation is the junior status. The method may also include, upon the determination to modify the maneuvering, changing a speed of the first mower, for example, pausing movement of the first mower along the first mow path. The method may also include, upon the determination to modify the maneuvering, transmitting from the transceiver a confirmation code to inform the second mower of the determination of the first mower.

The transmitting may be carried out on a periodic basis during the maneuvering and before receiving the second data packet. The method may also include updating the first mow path timetable that is included in the periodically transmitted first data packet. The method may also include determining a location of the first mower using a global navigation satellite system (GNSS).

We also disclose methods of operating an autonomous mower that include: providing the mower with a drive system, a memory unit, a wireless transceiver, and a controller coupled to the drive system, the memory unit, and the transceiver; storing a first mow path map in the memory unit; maneuvering the mower autonomously with the controller along a first mow path in accordance with the first mow path map; during the maneuvering, using the controller to monitor for a second mower by monitoring for a second data packet received from the transceiver; and upon receipt of the second data packet, using the controller to analyze the second data packet, the second data packet including a second mow path map that the second mower is traveling along.

The method may also include using the controller to compare the first mow path map to the second mow path map, and to determine whether to modify the maneuvering as a result of the comparison. The storing may also include storing a first digital code in the memory unit, and the second data packet may also include a second digital code, and the method may also include using the controller to compare the first digital code to the second digital code, and to determine whether to modify the maneuvering as a result of the comparison.

The controller may be configured to generate a first mow path timetable from the first mow path map, and the second data packet may include a second mow path timetable for the second mower, and the analysis by the controller may include comparing the first mow path timetable to the second mow path timetable. The providing may also include providing the mower with a GNSS device that communicates with a global navigation satellite system (GNSS), and the controller may couple to the GNSS device to provide a current location of the mower.

We also disclose methods of operating an autonomous mower that include: providing the mower with a drive system, a memory unit, a wireless transceiver, and a controller that couples to the drive system, the memory unit, and the transceiver; storing a first mow path map in the memory unit; maneuvering the mower autonomously with the controller along a first mow path in accordance with the first mow path map; and during the maneuvering: generating with the controller a first mow path timetable from the first mow path map, transmitting from the transceiver a first data packet that includes a substantial portion of the first mow path map timetable, and monitoring with the controller for a second mower by monitoring for a second data packet received from the transceiver.

The storing may include storing a first digital priority code in the memory unit, and the first data packet may include the first digital priority code, and the second information packet may include a second digital priority code. The method may also include, upon receipt of the second data packet, using the controller to analyze the second data packet, the second data packet including a second digital priority code, and to determine whether to modify the maneuvering as a result of the analysis. The first digital priority code may be a product serial number unique to the mower, and the second digital priority code may be a product serial number unique to the second mower.

The controller may be configured to generate a first mow path timetable from the first mow path map, and the method may also include: during the maneuvering, using the controller to monitor for a second mower by monitoring for a second data packet received from the transceiver; and upon receipt of the second data packet, using the controller to analyze the second data packet, the second data packet including a second mow path timetable, and to determine whether to modify the maneuvering as a result of the analysis.

We also disclose autonomous mowers that may include: mower blades, and a power takeoff (PTO) unit coupled to the mower blades; a drive system, a memory unit, and a wireless transceiver, the memory unit having stored therein a first mow path map and a first digital code; and a controller coupled to the PTO unit, the drive system, the memory unit, and the transceiver, and configured to maneuver the mower along a first mow path in accordance with the first mow path map. The controller may be configured to generate a first mow path timetable from the first mow path map to indicate when the mower will be at different points along the first mow path map, and may be further configured to transmit from the transceiver a first data packet that includes the first mow path timetable and the first digital code. The controller may be still further configured to monitor for the presence of a second mower while maneuvering the first mower along the first mow path, and to receive a second data packet from the second mower, and to make a determination of whether to modify the maneuvering based on a comparison of the second data packet with the first mow path timetable and the first digital code.

The mower may also include a seat, and one or more control levers coupled to the drive system, for use by a user, and a switch configured to select between autonomous operation of the mower by the controller and manual operation of the mower by the user.

Numerous related methods, systems, and articles are also disclosed.

These and other aspects of the present disclosure will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

The inventive articles, systems, and methods are described in further detail with reference to the accompanying drawings, of which:

FIG. 1 is a schematic plan view of a residential property having a mowing region;

FIG. 2 is a schematic plan view of a simplified property with a simplified mowing region, with multiple autonomous mowers working simultaneously in different portions of the region;

FIG. 3 is a schematic plan view of a portion of a mowing region with an autonomous mower traveling along a mow path in accordance with a mow path map;

FIG. 4 is a schematic plan view of a portion of a mowing region with two autonomous mowers operating in proximity to each other;

FIG. 5a is a schematic plan view of a mowing region and autonomous mowers similar to that of FIG. 4, and where the mow path maps of the respective mowers may create a hazard condition;

FIG. 5b is a schematic plan view of a mowing region and autonomous mowers similar to that of FIG. 4, and where the mow path maps of the respective mowers may not create a hazard condition;

FIG. 6 is a schematic representation of a data packet containing a mow path map;

FIG. 7 is a schematic representation of a data packet containing a timed mow path map;

FIG. 8 is a schematic representation of a data packet containing a mow path timetable;

FIG. 9 is a schematic representation of mow path-related data packets for two autonomous mowers;

FIGS. 10 through 13 are operational flow charts that can be carried out by a controller of an autonomous mower;

FIG. 14a is a perspective view of one embodiment of an autonomous mower capable of carrying out the disclosed operations, and FIGS. 14b, 14c, 14d are top, bottom, and side views thereof respectively;

FIG. 15 is a schematic plan view of an autonomous mower showing ranges and approximate shapes of its various detection or communications systems (not to scale);

FIG. 16 is a schematic block diagram of components and systems that may be included in an autonomous mower; and

FIG. 17 is a schematic diagram showing two autonomous mowers in communication with each other and in communication with other elements of a working system.

In the figures, like reference numerals designate like elements.

### DETAILED DESCRIPTION OF ILLUSTRATIVE EMBODIMENTS

As mentioned above, a number of improvements are disclosed herein relating to the design and operation of robotic autonomous mowers used to cut grass, weeds, brush, and the like. A primary aspect, but not the only aspect, relates to the avoidance of collisions between mowers. Each mower may include a transceiver allowing direct machine-to-machine digital communication with other mowers over a wireless data channel, and may continuously or periodically transmit a digital data packet that may include navigational information and/or a priority code such as a machine serial number. Detection of such a data packet may be used to alert a first mower of the presence of a second mower nearby. The navigational information may include a stored mow path map, mow path timetable, or the like showing the mower's current location and the path the mower is programmed to follow in the coming seconds or minutes. Comparison of a mower's own mow path map with that received from the other mower may be used to declare a hazard condition. Comparison of the priority codes may be used to determine which mower is to pause its motion or take some other evasive action.

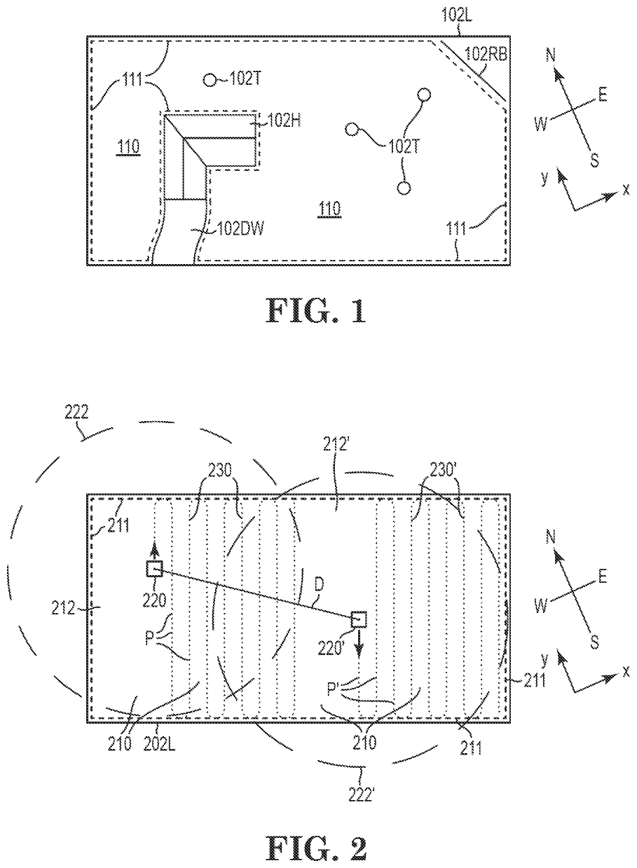

In FIG. 1, we see a bird's-eye view of an idealized residential property, which may provide a suitable setting for the autonomous mowers disclosed herein. The property may include a tract or plot of land 102L on which is located a house 102H, a driveway 102DW, and trees 102T. The property may also include other obstacles of significance to an autonomous mower. A row of bushes 102RB is shown that blocks off one corner of the property, but other obstacles such as fences, sheds, gardens, pools, and so forth may also be present. Between these various fixed items on the property is a yard or mowing region 110 on which is grown grass, weeds, brush, or the like, in need of occasional trimming or mowing.

The property is situated on the Earth in some fashion relative to the global navigational directions of north (N), south (S), east (E), and west (W) as shown. We may express the location of the property, or indeed any specific point in the mowing region, in terms of a corresponding (x,y) coordinate, where x is the longitude of the point and y is the latitude of the point. Modern satellite systems such as the Global Positioning System (GPS) and related detection devices are available that can be used to identify the location of an arbitrary point to an accuracy (for commercial, non-military applications) within about 3 to 4 inches, expressed in terms of longitude and latitude or in any other suitable way. The GPS system is one of a group of such satellite systems, which can each be referred to more generically as a global navigation satellite system (GNSS). Besides having the capability of providing accurate position information, the GPS system and other GNSS systems can provide very accurate time information. The time may be expressed in terms of Greenwich Mean Time (GMT), or any other suitable time standard.

A given mowing region may be defined in terms of one or more boundary lines, which may be encoded and stored in the memory of an autonomous mower to ensure the mower does not cross over a boundary line so it stays confined within the area to be mowed. The mowing region 110 of FIG. 1 is characterized by a single, closed-circuit boundary line 111.

To simplify our discussion, we show in FIG. 2 a plot of land 202L with a plain rectangular mowing region 210 bounded by a plain rectangular boundary line 211. The property is large enough to accommodate two (or more) autonomous mowers operating simultaneously on different portions of the mowing region 210. “Simultaneously” in this regard means that the operating/mowing time of one mower overlaps the operating/mowing time of the other mower, whether or not they begin at the same moment or end at the same moment. In the depicted scenario, a first autonomous mower 220 is tasked with mowing a left half of the property and a second autonomous mower 220′ is tasked with mowing a right half of the property. Any other suitable partition of the mowing region between the two mowers may of course also be used. Although only two mowers are shown for purposes of explanation, the techniques disclosed herein can accommodate larger systems of three, four, or more such mowers, whereupon the mowing region would be partitioned as desired between that number of individual mowers. When more than two mowers are used, the techniques described herein can be applied in a straightforward fashion to each combination of mower pairs in the group.

The figure shows the mowers part of the way through their respective mowing tasks, with mower 220 having already mowed the mowed area 212 and with mower 220′ having already mowed the mowed area 212′. The mower 220 is programmed to travel along a serpentine mow path map 230, and the mower 230′ is programmed to travel along a similar serpentine mow path map 230′. The mow path map 230 may be defined by a sequential set of points P that are stored in the electronic memory unit of mower 220. The mow path map 230′ may likewise be defined by a sequential set of points P′ that are stored in the electronic memory unit of mower 220′. Each point P and P′ may be defined as a specific (x,y) coordinate in longitude and latitude.

The autonomous mowers 220, 220′ may be programmed and operated completely independently of each other, except that their respective mow path maps may in some cases be configured in a coordinated fashion to avoid large areas of overlap to maximize operational efficiency, and except for the automated mower-to-mower interactions described herein. Otherwise, the machines may or may not start or end their mowing tasks at the same time, and may or may not maneuver along their respective paths at the same speed, and may or may not be of the same physical size or mowing capacity.

Each mower 220, 220′ is preferably equipped with a number of communications systems, including a transceiver to allow direct machine-to-machine (“M2M”) digital communication with other mowers over a wireless data channel. The transmission power and detection sensitivity of such a transceiver are preferably tailored to provide a communication range of limited extent, for example, the (free space) range may extend no more than 1000 feet (or 300 meters), or no more than 500 feet (or 150 meters), or no more than 300 feet (or 90 meters), or no more than 200 feet (or 60 meters), but preferably at least 50 feet (or 15 meters) or 100 feet (or 30 meters). In some embodiments, the communication range, as measured from the given mower or from the M2M transceiver itself, may extend approximately 300 feet in all directions, or it may vary with direction between a minimum range greater than 200 feet and a maximum range less than 500 feet. The M2M transceiver may in some embodiments operate at a 2.4 GHz electromagnetic band and may have a power output of 100 mW, or in a range from 50 to 200 mW.

The M2M transceivers and communication channel can then be used by the autonomous mowers for purposes of detecting whether any other such mowers are in the vicinity and thus potential hazards for collision. In this regard it is desirable for the communication range to be not so large that a given mower would detect a second mower so far away that it poses no possible hazard and thus would waste resources to engage in communication with it, but not so small that the given mower would first detect the second mower when it already is close to becoming a hazard. With a properly selected M2M communication range, each autonomous mower may be programmed to emit a digital data packet of its own while also monitoring for digital data packets transmitted by other mowers. A given autonomous mower may broadcast its own such data packets continuously, or, more preferably, on a periodic basis, for example, faster than once every 20 seconds, and faster than once every 10 seconds, but slower than once every one or two seconds. The periodic broadcast timing may for example be approximately one data packet broadcast every 5 seconds.

In FIG. 2, the M2M communication range of the mower 220 is shown schematically as a circle 222, and the M2M communication range of the mower 220′ is shown schematically as a circle 222′. Although shown as circles, the communication patterns of real life systems are seldom so uniform, and the reader should understand that M2M communication patterns that deviate significantly from perfect spatial uniformity can also be used.

As illustrated, the mowers 220, 220′ are separated by a distance D that is greater than the communication range of either of their M2M transceivers. Consequently, neither mower 220, 220′ is aware of the other mower. However, in other scenarios the mowers 220, 220′ may maneuver to positions that are closer to each other and within the range of their M2M communication channel.

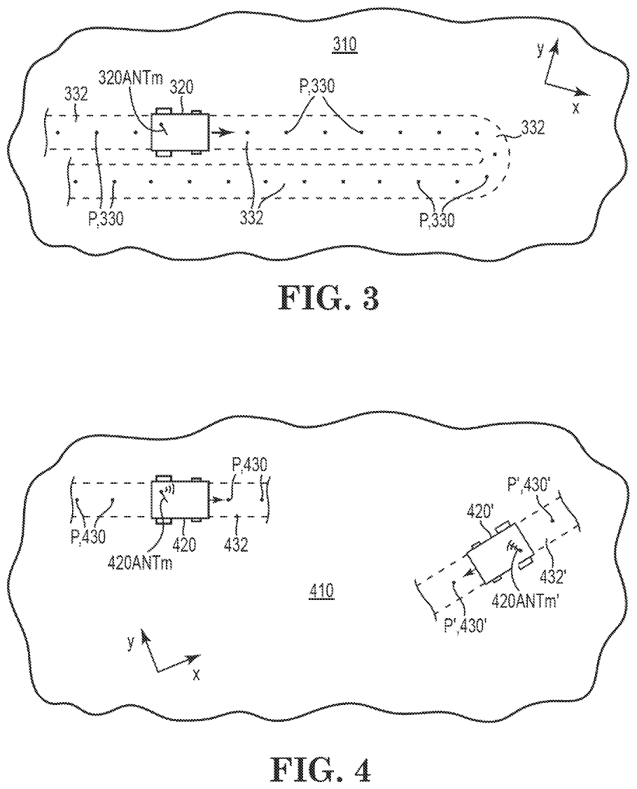

Turning then to FIG. 3, we see there a plan view of a portion of a mowing region 310 with an autonomous mower 320 traveling along a mow path 332 in accordance with a mow path map 330. The mow path map 330 may be defined as an ordered sequence of points P which, if followed by the mower 320 with the help of a GNSS system and a suitable microcontroller and drive system, guide the mower 320 along the desired mow path 332. The points P may be expressed in terms of (x,y) longitude, latitude coordinates or in any other suitable way, and may be stored in a memory unit of the mower 320 so as to be accessible to the on-board electronic controller (microcontroller). As the mower 320 maneuvers along the mow path map 330, the controller can use real-time position information from the GNSS system to keep track of where it is on the mow path map and which points P are next in line (ahead of it) on the path. The mow path map 330 may typically include one or more portions that are serpentine in shape to help the mower make progress in an efficient manner in its task of mowing a given mowing region or portion thereof. The mowing path 332 of FIG. 3 shows, for purposes of illustration, a turn of small but finite radius resulting in two straight parallel strips separated by a narrow non-mowed band. The turn can of course be made tighter (smaller radius) to eliminate such non-mowed areas. Other turns and maneuvers are also contemplated, e.g., a box turn can comprise two 90 degree zero turns separated by a short forward motion of the mower.

The mower 320 also preferably includes an antenna 320ANTm as part of its M2M transceiver for communicating directly with other mowers, as discussed elsewhere herein.

One scenario of interest to us is where two autonomous mowers operate in the same general vicinity of a mowing region. Such a scenario is shown in simplified fashion in FIG. 4. Two autonomous mowers 420, 420′ may be the same as or similar to the mower 320 of FIG. 3. As such, they may include an on-board electronic controller, memory unit, drive system, GNSS unit, M2M transceiver, and antennas 420ANTm, 420ANTm′ for their M2M transceivers. Stored in the memory unit of the mower 420 is a mow path map 430 comprising for example an ordered sequence of points P. The mower 420 uses the mow path map 430 to guide it along a mow path 432. Stored in the memory unit of the mower 420′ is a mow path map 430′ comprising for example an ordered sequence of points P′. The mower 420′ uses the mow path map 430′ to guide it along a mow path 432′. The memory units of the mowers may also include a machine serial number or other digital code that can be used as a priority code.

Each mower 420, 420′ preferably uses its M2M transceiver to broadcast digital data packets and to monitor for any detectable digital data packets emitted from other mowers. Detection of such a data packet can then be used to identify the presence of other autonomous mowers in the vicinity, i.e., within the communication range of the M2M system. In FIG. 4, the mowers 420, 420′ are assumed to be close enough to be within each other's M2M communication range, which is to say, the separation D between the mowers (refer to FIG. 2) is less than the M2M communication range for both mowers.

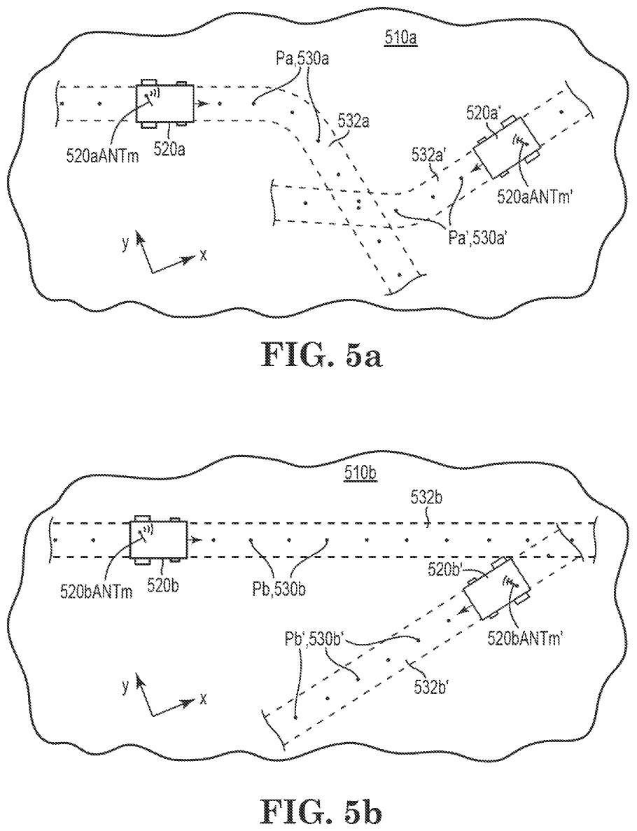

Given that each mower 420, 420′ (or more precisely, the electronic controller for each mower) is thus aware of the existence of the other mower in the vicinity, the next question becomes whether the controller declares the existence of a hazard condition which may call for some type of evasive action by one or both of the mowers. The technique or algorithm used by the controller may employ any number of suitable logical steps and input parameters in its determination of the existence (or not) of a hazard condition. In a simplest approach, the algorithm may declare a hazard condition simply on the basis that another mower has been detected in the vicinity. In a more advanced approach, the received data packet may contain information about the other mower's current position, heading (direction of travel), and/or speed, and the algorithm may then analyze this current navigational information for the two mowers to calculate whether a collision or near-collision is likely to occur, in order to make a determination of hazard condition. In a preferred approach, the received data packet contains not only current navigational information such as position, heading, and speed, but also information about the path the other mower is programmed to follow, in particular, the mow path map or a related data set. In this latter approach, the current navigational information of the two mowers is insufficient by itself to declare a hazard condition (unless the separation between the mowers is dangerously small). The reader will better appreciate this fact by comparing FIG. 4 with FIGS. 5a and 5b.

FIGS. 5a and 5b show two autonomous mowers that may be identical to those of FIG. 4 in terms of their current navigational characteristics (present locations, separation distance D, headings, speeds). But whereas FIG. 4 reveals only a small part of each mower's mow path map, FIGS. 5a and 5b show a longer portion of those maps for two different scenarios: one scenario (FIG. 5a) in which a hazard condition may be declared, and another scenario (FIG. 5b) in which it may not be declared. Such longer portions of the mow path maps are preferably communicated back and forth between the two mowers over the M2M communication channel, so that each mower's controller can compare or analyze the two maps to make a better assessment of the hazard level and the potential for a collision.

Thus, in FIG. 5a, the autonomous mower 520a and its associated mow path 532a and mow path map 530a and related points Pa may be substantially the same as mower 420, mow path 432, mow path map 430, and points P respectively as described above. Similarly, the autonomous mower 520a′ and its associated mow path 532a′ and mow path map 530a′ and related points Pa′ may be substantially the same as mower 420′, mow path 432′, mow path map 430′, and points P′ respectively as described above. The mowers 520a, 520a′ carry out their mowing operations in a mowing region 510a and have antennas 520aANTm, 520aANTm′ for use with their respective M2M transceivers.

The electronic controller for each mower 520a, 520a′ can then analyze the two mow path maps and, from that analysis, rapidly determine that the two mowers are on a collision or near-collision course, well before any such collision takes place thanks to the forward-looking (future) information contained in the exchanged mow path maps. If the exchanged information includes not only the respective mow path maps but also mow path timetables, the analysis will show not only position points that are too close to each other, but that the expected times for those points (i.e. the time at which a given mower is expected to be at a given point) are also too close to each other.

In FIG. 5b, the autonomous mower 520b and its associated mow path 532b and mow path map 530b and related points Pb may again be substantially the same as mower 420, mow path 432, mow path map 430, and points P respectively. The autonomous mower 520b′ and its associated mow path 532b′ and mow path map 530b′ and related points Pb′ may be substantially the same as mower 420′, mow path 432′, mow path map 430′, and points P′ respectively. The mowers 520b, 520b′ carry out their mowing operations in a mowing region 510b and have antennas 520bANTm, 520bANTm′ for use with their respective M2M transceivers.

The electronic controller for each mower 520b, 520b′ can then analyze the two mow path maps and, from that analysis, rapidly determine that the two mowers are not on a collision or near-collision course thanks again to the forward-looking (future) information contained in the exchanged mow path maps. If the exchanged information includes not only the respective mow path maps but also mow path timetables, the analysis will show that although some position points between the two paths are too close to each other, the expected times for those points (i.e. the time at which a given mower is expected to be at a given point) are very far apart. That is, when one mower is at or near the point of intersection of the two mow paths, the other mower is far away (both in terms of distance and time) from that point.

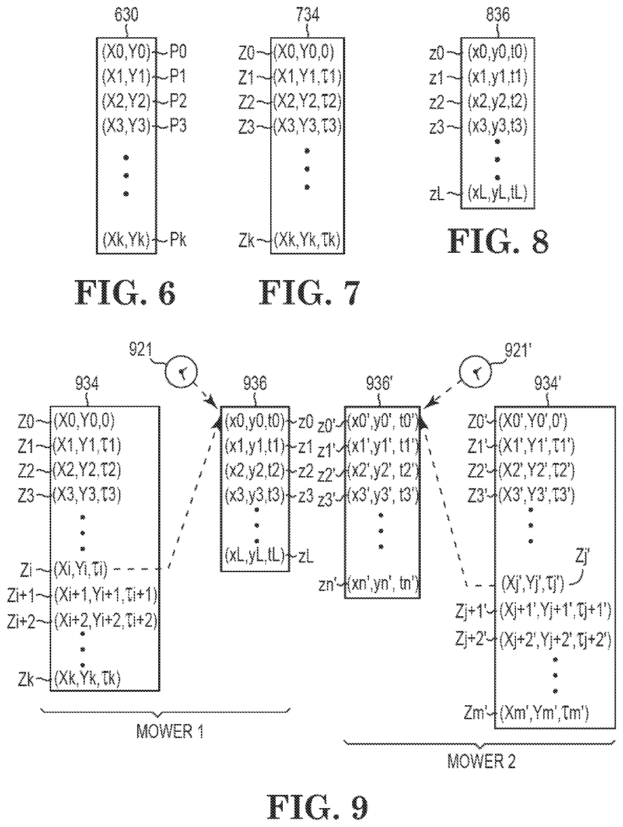

In the foregoing discussion we have mentioned mow path maps, mow path timetables, and related digital data sets and data packets. FIGS. 6 through 9 show visual representations of such things and concepts to help the reader better understand the invention.

A mow path map, or data packet containing or embodying such mow path map, is shown as item 630 in FIG. 6. This data packet 630 may be resident in the memory unit of a given mower for use by the mower's controller to guide the mower along the desired mowing path, and it may also be broadcast in whole or in part in a suitable digital format by such mower to other mowers over the M2M communication channel using the M2M transceiver. The data packet 630 may include, or consist essentially of, or consist of, an ordered sequence of points P0, P1, P2, P3, . . . Pk, where k is an integer. Each point represents a specific geographic location along the desired mow path. A first point P0 represents the beginning or starting point for the mow path, and the last point Pk represents the end or end point for the mow path. The value k (or k+1) is thus an integer substantially equal to the total number of points that define the mow path map. The point locations are preferably expressed in terms of longitude and latitude, e.g., (X0, Y0) for P0, (X1, Y1) for P1, (X2, Y2) for P2, (X3, Y3) for P3, . . . , (Xk, Yk) for Pk, but alternative coordinate systems can also be used.

Note that the data packet 630 inherently includes distance information since the distance between any two adjacent points is readily calculated as the square root of the sum of the squares of the differences between the X values and the Y values. Heading information is also inherently included in the data packet 630 since the direction vector from any given point to the next point in the sequence is readily calculated using the difference between the X values and the difference between the Y values of such points.

The points P0, P1, etc. that make up the mow path map may be set up in a variety of ways. In a first approach, the points may be defined according to a uniform physical spacing, wherein the distance (spacing) from point P0 to point P1 is the same as that from P1 to P2, and from P2 to P3, . . . and from Pk-1 to Pk. In a second approach, the points may be defined according to a uniform time increment, wherein the travel time (time increment) for the mower to move from point P0 to point P1 is the same as that from P1 to P2, and from P2 to P3, etc., all the way to the end point Pk. In this second approach, points in the sequence that are physically closer together are indicative of slower speeds (e.g. for points defining a sharp curve or turn of the desired mow path), and points that are farther apart are indicative of faster speeds (e.g. for points defining a straight section of the desired mow path). In still other approaches, the points may be defined according to a combination of uniform physical spacing and uniform time increment, or according to neither.

Closely related to a mow path map is a timed mow path map. Whereas the mow path map is used to tell the autonomous mower's on-board electronic controller where the mower should go, from one point to the next on the mow path, the timed mow path map further tells the controller at what time the mower should be at each such point along the path, or how much time it should take for the mower to travel from one point to the next. Such a timed mow path map, or a data packet containing or embodying such timed mow path map, is shown as item 734 in FIG. 7. This data packet 734 may be resident in the memory unit of a given mower for use by the mower's controller to guide the mower along the desired mowing path, and it may also be broadcast in whole or in part in a suitable digital format by such mower to other mowers over the M2M communication channel using the M2M transceiver.

The data packet 734 may include, or consist essentially of, or consist of, an ordered sequence of data entries Z0, Z1, Z2, Z3, . . . Zk, these data entries corresponding to the respective geographic location points P0, P1, P2, P3, . . . Pk described above, but with the addition of a time value τ (greek letter tau) associated with each location point. The integer k is thus the same in FIG. 7 as in FIG. 6. The time value t represents a relative time that is not associated with the actual current time, such as would be reported by a user's watch or by a GNSS system. The time value t is independent of the actual current time. Note that the timed mow path map or data packet 734 includes a mow path map, in this case, mow path map 630 of FIG. 6.

The time value t for the starting point of the mow path map may be set to zero, see data entry Z0. The time value τ1 (see data entry Z1) for the next point of the mow path map may be the expected travel time for the mower to move from point P0 (see Z0) to point P1 (see Z1). The next time value, τ2 (see data entry Z2), may be incremental or cumulative, i.e., it may be the expected travel time from P1 to P2 (incremental), or it may be the expected travel time from P0 (to P1 and then) to P2 (cumulative). The remaining time values may likewise be incremental or cumulative, e.g., the time τ3 in data entry Z3 may be the expected travel time from P2 to P3 (incremental), or the expected travel time from P0 (to P1 and then to P2 and then) to P3 (cumulative), and so forth. If the relative time values t in the data packet 734 are incremental, on-board electronic controller can easily calculate the desired speed for any point along the mow path (and can control the mower to such desired speed) by dividing the distance between a given point and the previous point by the time value t for the given point. Otherwise, if the time values τ are cumulative, the controller can calculate the desired speed for any point by dividing the distance between the given point and the previous point by the difference between the time values τ for the two points.

Closely related to both the mow path map 630 and the timed mow path map 734 is a mow path timetable, such as the one labeled 836 in FIG. 8. The label 836 may refer to the mow path timetable itself or to the data packet that contains or embodies it. The mow path timetable is similar to the timed mow path map insofar as each of its ordered rows or data entries includes both a position component and a time component. But the time component in the mow path timetable is measured in terms of an actual or current time reference (capable of being interpreted by other mowers in synchrony with the on-board clock or time reference of such other mowers) rather than a relative time t. Furthermore, the mow path timetable may contain only a subset of the rows or data entries of the mow path map or the timed mow path map, for example, (1) only the rows or data entries corresponding to the mower's current position on the mow path map, plus rows or data entries corresponding to the remaining portion of the mow path map between the current position and the last point on such map, or (2) only the rows or data entries corresponding to the mower's current position on the mow path map, plus a limited number of rows or data entries corresponding to a group of sequential points on the mow path immediately after the current position. Thus, the mow path timetable may be substantially smaller, and have a smaller data size, than the mow path map or timed mow path map.

The limited number of rows or data entries in the mow path timetable may correspond to a limited travel time and/or a limited travel distance of the mower relative to its current position and time. The limited travel time may be 7 seconds, or at least 5, or 10, or 20, or 30, or 40, or 50 seconds, and/or less than 2 minutes or less than 1 minute or less than 50, or 40, or 30, or 20 seconds. The limited travel time may be in a range from 5 to 60 seconds, or 5 to 40 seconds, or 5 to 20 seconds. The limited travel distance may be 50 feet, or at least 10, or 20, or 30, or 40, or 50 feet, and/or less than 200 or 100 or 80 or 60 feet. The limited number of rows or data entries in the mow path timetable may also correspond to a combination of time and distance, e.g., the greater of 7 seconds of travel time or 50 feet of travel distance of the mower. Regardless of the exact number or numbers selected, the mow path timetable preferably contains enough rows/data entries to include its current position and time, and its navigation plan (both expected position and expected time) for a distance and/or time into the future that is long enough to identify a potential collision event with another mower but short enough that the mow path timetable is substantially smaller in terms of data size compared to its associated (complete) timed mow path map so that it can be communicated faster and analyzed/processed faster by the on-board controller (while the mower is moving at its programmed speed) with minimal delay time.

Thus, in FIG. 8, we see the data packet 836 representing a mow path timetable for the timed mow path map 734 of FIG. 7. Each row or data entry for the packet 836 may include two-dimensional location coordinates x and y for the actual or expected location of the mower in terms of longitude and latitude, and a time measured in terms of current actual time. The packet 836 may be continually updated by the mower's on-board electronic controller as the mower travels along its programmed mow path, so that in the first row or data entry (x0, y0, t0), x0 and y0 are the current longitude and latitude coordinates as detected by the mower's GNSS system, and t0 is the current actual time. If the mower is half way through its programmed mow path, this current position (x0,y0) will be half way down the mow path map and half way down the timed mow path map. In the next row of the timetable, (x1, y1, t1), x1 and y1 are the expected position coordinates for the next point in the mow path as determined from the mower's actual current position (x0, y0) and the change in position as dictated by the mow path map/timed mow path map. The time t1 is the expected time of arrival (ETA) of the mower at that point as determined from the mower's current time to and the time increment as dictated by the timed mow path map.

In the next row of the timetable, (x2, y2, t2), x2 and y2 are the expected position coordinates for the next point in the mow path as determined from the calculated coordinates (x1, y1) and the change in position as dictated by the mow path map/timed mow path map. The time t2 is the expected time of arrival (ETA) of the mower at that point as determined from the mower's estimated time t1 and the time increment as dictated by the timed mow path map. Remaining rows of the timetable 836, up to the last row (L), are defined and calculated in like fashion. The total number (L) of rows or coordinates in the timetable 836 is preferably substantially less than the total number (k) of rows or coordinates in the mow path map 630 or the timed mow path map 734. L may be selected to correspond to at least 7, 10, or 20 seconds of travel time, or at least 50 feet of travel distance, or both. Typically, L is at least 5 or at least 10, and less than 200 or 100.

FIG. 9 combines some of the information discussed in connection with FIGS. 6 through 8 and applies it to a scenario where a first autonomous mower and a second autonomous mower encounter each other while carrying out their respective mowing tasks according to the mow path maps stored on the respective on-board memory units.

On the left side of the figure, data packets of the first mower are shown. Data packet 934 is a timed mow path map for the first mower. The first mower's on-board controller reads this data packet from the memory unit and interprets this information as instructions for where and how fast to maneuver the mower along the specified first mow path. The timed mow path map 934 has an integer number k of rows or data points. Other aspects of the timed mow path map 934 are the same as or similar to those of the timed mow path map 734 of FIG. 7, and will not be discussed further.

FIG. 9 represents a moment in time when the first mower has progressed along its mow path map to the point Zi, characterized by idealized longitude and latitude coordinates (Xi, Yi), and by a relative time value τi. For purposes of the first mower's mow path timetable 936, this point is translated into the current actual location (x0, y0) e.g. as measured by the GNSS system, which typically will differ only minimally from the idealized position (Xi, Yi). The relative time value τi is similarly translated to the current actual time to, whether by the first mower's on-board clock 921 or the actual current time received from the GNSS system. Rows or data entries in the mow path timetable 936 after the first entry z0 (see entries z1, z2, z3, . . . zL), each containing an estimated actual position and an estimated time of arrival of the first mower at that position, are computed by the controller based on the information in the timed mow path map 934 and the numerical values of the first entry z0, as described in connection with FIG. 8.

On the right side of the figure, data packets for the second mower are shown. Data packet 934′ is a timed mow path map for the second mower. The second mower's on-board controller reads this data packet from the memory unit and interprets this information as instructions for where and how fast to maneuver the mower along the specified second mow path. The timed mow path map 934′ has an integer number m of rows or data points. Other aspects of the timed mow path map 934′ are the same as or similar to those of the timed mow path map 734 of FIG. 7, and will not be discussed further.

FIG. 9 represents a moment in time when the second mower has progressed along its mow path map to the point Zj′, characterized by idealized longitude and latitude coordinates (Xi′, Yi′), and by a relative time value τj′. For purposes of the second mower's mow path timetable 936′, this point is translated into the current actual location (x0′, y0′) e.g. as measured by the GNSS system, which typically will differ only minimally from the idealized position (Xj′, Yj′). The relative time value τj′ is similarly translated to the current actual time t0′, whether by the second mower's on-board clock 921′ or the actual current time received from the GNSS system. Note that the two clocks 921, 921′ will be substantially synchronized, and the times to and t0′ will be substantially the same. Rows or data entries in the mow path timetable 936′ after the first entry z0′ (see entries z1′, z2′, z3′, . . . zn′), each containing an estimated actual position and an estimated time of arrival of the second mower at that position, are computed by the controller based on the information in the timed mow path map 934′ and the numerical values of the first entry z0′, as described in connection with FIG. 8.

At the moment in time depicted in FIG. 9, the first mower broadcasts its mow path timetable 936 from its M2M transceiver to inform other mowers of its existence in the area and its planned mowing path and timing. At or about the same time, the second mower broadcasts its mow path timetable 936′ from its M2M transceiver to inform other mowers of its existence in the area and its planned mowing path and timing. If the two mowers are within the M2M communication range of each other, they may each (1) compute the separation D between the two mowers by comparing (x0, y0) with (x0′, y0′), and (2) determine if a collision or near-collision is likely to occur based on a comparison of the two mow path timetables 936, 936′. If such a collision or near-collision is determined to be likely, a hazard condition is declared, and the mowers may further exchange over the M2M communication channel their respective serial numbers or other digital priority codes. Comparison of such codes (by both mowers independently) may then be used, such that (only) one of the mowers designates itself as junior, thereby stopping, slowing, or otherwise changing its motion until the hazard condition no longer exists, allowing the other mower to continue along its mowing path with no interruption in its motion.

Modifications to the disclosed techniques and elements are within the scope of this document. For example, the data packets 936, 936′ that are broadcast by the different mowers may include additional information. Each row of the mow path timetable 936 may include a digital code such as the first mower's manufacturer's serial number or other unique code useful for priority comparison purposes. Thus, the entries (x0, y0, t0), (x1, y1, t1), (x2, y2, t2), etc. may be changed to (code1, x0, y0, t0), (code1, x1, y1, t1), (code1, x2, y2, t2), etc. Transmitting the mower's serial number or similar priority code “code1” with each entry or row of the mow path timetable can help to ensure that another mower receiving this information over the M2M communication channel will not confuse this information from the first mower with similar information it may receive from a third mower that may also be in the vicinity. The same thing may of course be done with the second mower, whereupon the entries (x0′, y0′, t0′), (x1′, y1′, t1′), (x2′, y2′, t2′), etc. may be changed to (code2, x0′, y0′, t0′), (code2, x1′, y1′, t1′), (code2, x2′, y2′, t2′), etc., where code2 is the serial number or similar priority code for the second mower. Alternatively, for faster communication times, the priority codes code 1, code 2 may be transmitted only once (e.g. at the beginning or at the end) for each of the respective transmitted packet of points or entries.

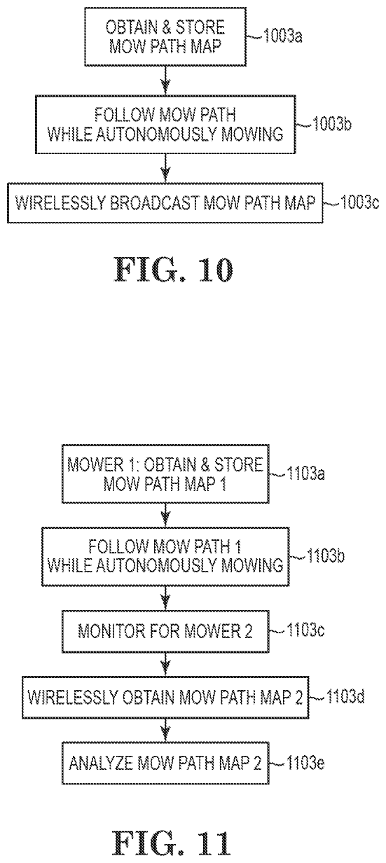

Various operational flow charts that can be carried out by the controller of a given autonomous mower are shown in FIGS. 10 through 13.

In FIG. 10, a relatively simple process is shown. At step 1003a, a mow path map, as described herein, is obtained and stored. The mow path map may be obtained in a number of ways. In one way, a human operator temporarily overrides the automation function and manually maneuvers the mower along a mow path considered by the operator to be suitable. While the human operator is doing this, the on-board controller may monitor and record the human-controlled path of the mower, such as by monitoring and recording the position and time coordinates of the mower as reported by the GNSS unit. The recorded path may then be used as the mow path map. Alternatively, a machine algorithm (e.g. using artificial intelligence or otherwise) may be used to calculate an optimal or suitable mow path map within the limits of a defined outer boundary. In any case, the mow path map so obtained may then be stored, for example in a memory unit on board the autonomous mower.

At step 1003b, the mower, under the control of the on-board electronic controller, is made to follow a mow path substantially corresponding to the mow path map. The controller may carry this out by reading the mow path map information that was stored in step 1003a, comparing the position information in the mow path map with the actual position information received from a GNSS unit or the like, and operating the drive system of the mower (such as by the use of electronic actuators coupled to the left and right wheels of the mower by hydraulic transmissions) to control the direction and speed of the mower to cause the actual position to match the positions of the various sequential points in the mow path map. While this is going on, the controller also controls the power take-off (PTO) unit of the mower to cause the mower blades to engage so as to cut the grass, weeds, brush, or the like of the mowing region while the mower advances along the mow path.

At step 1003c, the controller wirelessly broadcasts the mow path map. This may preferably be done using the M2M devices and communication channel discussed herein, where the controller couples to the M2M transceiver to accomplish the data packet transmission. The mow path map may be broadcast in various ways. In one way, the entire mow path map (see e.g. item 630 of FIG. 6) may be transmitted. In another way, a substantial portion of the mow path map (e.g. more than one or two points, or at least the current position point and the next two, three, four, or more points on the map) may be transmitted. In another way, an entire timed mow path map (see e.g. item 734 of FIG. 7), or substantial portion thereof (e.g. more than one or two points, or at least the current position point and the next two, three, four, or more points on the timed mow path map), may be transmitted. In another way, a mow path timetable (see e.g. item 836 of FIG. 8), or a substantial portion thereof (e.g. more than one or two points, or at least the current position point (and current time) and the next two, three, four, or more points on the map and their associated estimated arrival times), may be transmitted. Recall in this regard that a timed mow path map and a mow path timetable each include at least a portion of the mow path map.

Another related useful process is shown in FIG. 11. At step 1103a, a first mow path map as described herein is obtained and stored in the memory unit of a first autonomous mower. At step 1103b, the first mower, under the control of an on-board electronic controller, is made to follow a first mow path substantially corresponding to the first mow path map, while controlling the power take-off (PTO) unit to engage the mower blades to cut the grass, weeds, etc. as the mower advances along the mow path. See in this regard the descriptions of steps 1003a and 1003b above.

Then at step 1103c, the first mower monitors for the presence of a second autonomous mower. This may be done by the electronic controller of the first mower monitoring the M2M transceiver for any incoming data packets originating from such a second mower. The method then further involves, at step 1103d, the first mower wirelessly receiving a mow path map from the second mower. We refer to the received mow path map as a second mow path map, but in view of the other discussions herein, the reader will understand that this may take the form of a complete or substantial portion of a mow path map from the second mower, or a complete or substantial portion of a timed mow path map from the second mower, or a long or short mow path timetable from the second mower. Then at step 1103e, the controller for the first mower may analyze the second mow path map. The analysis may include comparing the second mow path map with the first mow path map, such as to determine whether the two maps have any intersection or near-intersection points. Other analyses of the second mow path map may also or instead be done by the controller.

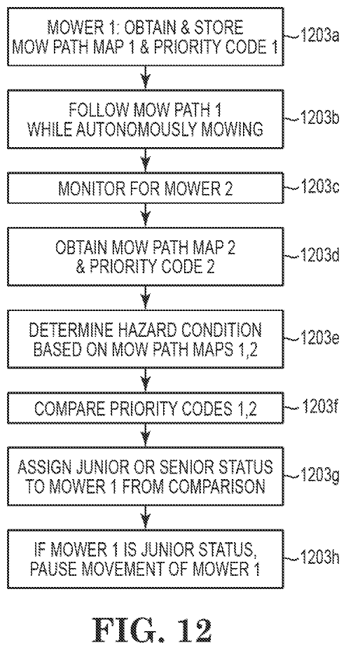

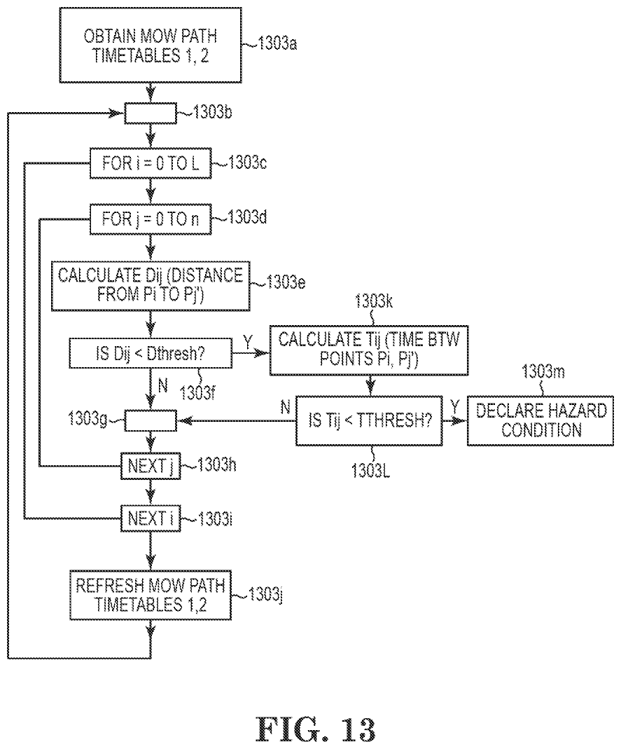

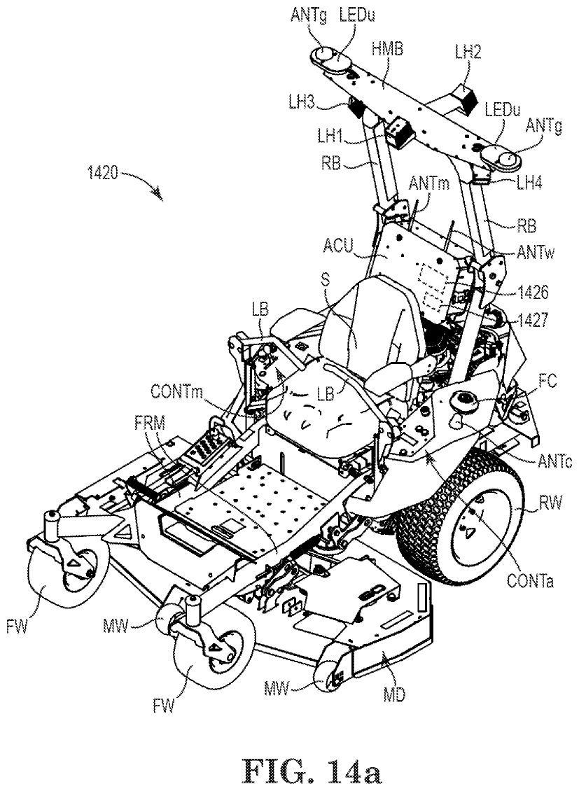

Another useful process capable of being carried out by an autonomous mower is shown in FIG. 12. At step 1203a, a first mow path map as described herein is obtained and stored in the memory unit of a first autonomous mower. See in this regard the description of step 1003a above. Also in step 1203a, a first priority code is obtained and stored. This may be done at the factory where the first mower is manufactured, by storing in the memory unit of the first mower a machine serial number that can serve as a priority code. Alternatively, a code that is not the machine serial number may be selected for the first mower and stored in its memory unit. At step 1203b, the first mower, under the control of an on-board electronic controller, is made to follow a first mow path substantially corresponding to the first mow path map while engaging the mower blades to cut the grass, weeds, etc. as the mower advances along the mow path. See in this regard the descriptions of step 1003b above.

At step 1203c, the first mower monitors for the presence of a second autonomous mower, as discussed in connection with step 1103c above. At step 1203d the first mower wirelessly receives a mow path map from the second mower. Refer to step 1103d above. Also at step 1203d, the first mower also wirelessly receives a priority code from the second mower. Priority codes are discussed at length elsewhere and will not be further described here. The priority code may be embedded in a data stream or packet that also includes the second mow path map as broadcast by the second mower.

Then at step 1203e, the controller for the first mower may determine whether a hazard condition exists based on a comparison or other analysis of the first and second mow path maps. The analysis may include comparing these maps to determine whether there are any intersection or near-intersection points, and it may also include a comparison of timing information relating to the two maps such as by analyzing the mow path timetables for the first and second mowers. From such analysis or analyses, the controller for the first mower may make an automated determination that a hazard condition exists. At step 1203f, the first mower's controller makes a comparison of the first and second priority codes. In some cases this may be as simple as determining which priority code is greater than the other, or which is less than the other. At step 1203g, the first mower's controller may assign to itself a junior status based on the comparison. The junior status may be a result of having a smaller priority code than the other mower, or vice versa. Preferably, the first and second mowers both carry out the determination of the hazard condition, and compare the priority codes, and assign the junior or senior status, in the same way, such that only one of the mowers designates itself with the junior status. At step 1203h, the first mower's controller pauses the movement of the first mower along its mowing path, or may take some other evasive action, as a result of obtaining a junior status in step 1203g. The first controller may maintain this pause for a predetermined period of time, after which it may return to step 1203e to reassess the presence of a hazard condition based on updated information it receives from the second mower.

Each mower may also be configured to communicate to the other mower, preferably via the M2M communication channel (wirelessly), a digital confirmation code to inform the other mower of the status determination it has made. Thus, if the first mower determines it is junior relative to the second mower (step 1203g), the first mower may transmit or broadcast a confirmation code that indicates the first mower has a junior status relative to the second mower. And the second mower may likewise communicate to the first mower a digital confirmation code to inform the first mower of the status determination it has made. Of course, if the first and second mowers use the same control logic and compare the same mow path maps and priority codes, the two mowers will make different or complementary status determinations: if the first mower determines it is junior, then the second mower will determine it is senior (or, stated differently, not junior), and vice versa. Thus, in the described scenario, the second mower's controller will determine that the second mower has a senior status relative to the first mower, so the confirmation code broadcast by the second mower will indicate the second mower has a senior status (or, stated differently, does not have a junior status) relative to the first mower. This additional communication step can be used to safeguard against the possible circumstance in which the first and second mowers determine that they have the same status, whether both junior (in which case neither of them pauses its motion or otherwise takes evasive action, which may result in a collision or near-collision) or both senior (in which case both of them pause their motion or otherwise take evasive action, which may result in a standoff). Each mower may be programmed to compare the status of the other mower as indicated in the confirmation code it received from that mower with its own status determination, and, if in the unlikely event the status determinations are the same, to take further action to resolve the discrepancy.

Alternatively, instead of transmitting a separate digital confirmation code, each mower may instead simply continue to transmit (whether continuously or periodically) its mow path timetable, which can be used by the other mower for confirmation of status, since the estimated arrival times in the (updated) mow path timetable transmitted by the junior mower will change greatly due to the junior mower's change in speed.

As mentioned above, when more than two mowers are used, the techniques described herein can be applied in a straightforward fashion to each combination of mower pairs in the group. For example, when a first, second, and third mower are operating in the same vicinity and are close enough to detect each other's presence, each mower may carry out the process of FIG. 12 with each of the two other mowers. The first mower may be junior to the second mower but senior to the third mower. In that case the third mower would be junior to both the first and second mower, and the second mower would be senior to both the first and third mower. Assuming a hazard condition exists for all three mowers (for all three pairs of mowers), the first mower would pause its movement because it self-designates as junior relative to the second mower (even though it also self-designates as senior relative to the third mower), and the third mower would also pause its movement because it self-designates as junior relative to both the first and second mowers. The second mower would not pause its movement but would continue along its mowing path because it does not self-designate as junior to any other mower. From this simple example one can see that, when multiple mower pairs are involved, it is more significant to know whether a given mower designates itself as junior to any other mower than to know if that mower designates itself as senior (or, does not designate itself as junior) to any other mower. In the example, after the second mower proceeds so far along its path that it moves out of range of the first and third mowers, the situation then simplifies to just a two-mower encounter between the first and the third mower, and the third mower would stay paused in its motion and allow the first mower to resume traveling along its mowing path because the third mower is junior to the first mower.

A flow chart that shows one way a controller may automatically make a determination of a hazard condition is provided in FIG. 13. In brief, the method may involve comparing each pair of position points between a first mow path timetable (or map) and a second such timetable/map to identify any intersection or near-intersection points. A value that is fairly representative of the distance between each such pair of points can be calculated, and checked to see if it is less than a predetermined threshold separation distance Dthresh, the threshold separation distance being selected to identify points that are too close to each other from the standpoint of a possible collision or near-collision. If no point pairs are less than (or equal to) the threshold Dthresh, the method may refresh or update the first and second mow path timetables and carry out the search for intersection or near-intersection points on the new data sets. The refresh/update may go on indefinitely as long as the first mower continues to receive a mow path timetable or related data packet from the second mower. If on the other hand the method encounters a point pair that is less than (or equal to) the threshold Dthresh, it may then compare the times associated with those points, i.e., the time the first mower is estimated to be at the first point of the pair, and the time the second mower is estimated to be at the second point of the pair. If the difference between those two times is too small, i.e., less than (or equal to) a threshold time difference Tthresh, a hazard condition may be declared. Otherwise, if the difference between the two times is larger than Tthresh, meaning that although the points are close to each other spatially the mowers will not be at those points at the same time or even close to the same time, the method moves on to the next point pair in its evaluation.

Thus, in step 1303a, a first autonomous mower obtains its own (first) mow path timetable as well as a (second) mow path timetable from a second autonomous mower. The first timetable would typically be already resident in the first mower's memory unit. The second timetable would typically be received over the first mower's M2M transceiver from the second mower. Operation then proceeds through junction box 1303b to step 1303c, where an integer i is incremented from 0 to L, and step 1303d, where an integer j is incremented from 0 to n. These steps assume the first mow path timetable has a total of L+1 rows or data points (see data packets 836, 936 in FIGS. 8 and 9) and the second mow path timetable has a total of n+1 rows or data points (see data packet 936′ in FIG. 9). The incrementing carried out by steps 1303c and 1303d ensure that every point pair between the two timetables will be compared and evaluated. Such a comparison is carried out one point pair at a time in step 1303e, in which the distance between a point Pi in the first timetable (such point Pi corresponding to a longitude and latitude (xi, yi), or the like), and a point Pj′ in the second timetable (such point Pj′ corresponding to a longitude and latitude (xj′, yj′), or the like) is calculated. Such calculated distance, referred to here as Dij, may be the actual distance, which would involve a square root computation on the sum of the squares of the differences between the longitude and latitude coordinates. To reduce computational demands on the controller and speed up the system response time, the calculated distance may instead be an approximate distance parameter that uses simpler computational operations, such as the difference between the longitudinal coordinates added to the difference between the latitudinal coordinates, or another such simple computation.

After the separation distance Dij between points Pi and Pj′ is calculated, it is compared to the threshold separation distance Dthresh in step 1303f. The threshold distance Dthresh may be selected as desired, but is preferably not so small that a hazard condition could only be declared for two points that almost exactly the same, and preferably not so large that a hazard condition could be declared for two points that are a safe distance apart. Dthresh is also preferably substantially less than the M2M communication range of the mowers, e.g., less than 10% of such range. Preferably, Dthresh is approximately 10 feet (or 3 meters), or in a range from 5 to 15 feet (or 1.5 to 5 meters).

If the calculated distance Dij is not less than (or equal to) Dthresh, operation proceeds through junction box 1303g to the j, i increment boxes 1303h, 1303i respectively. If, after all the values of i and j are used, no points satisfy the condition that Dij<Dthresh (step 1303f), operation passes to step 1303j, whereupon the first and second mow path timetables are updated or refreshed, assuming such updates are then available, and the steps from 1303b through 1303j are then repeated.

If on the other hand a point pair (Pi, Pj′) is encountered in which Dij is less than (or equal to) Dthresh, operation then proceeds from step 1303f to step 1303k. At step 1303k, the estimated arrival times of the respective mowers at the respective points, i.e., the expected arrival time of the first mower at the point Pi and the expected arrival time of the second mower at the point Pj′, are compared and the time difference Tij is calculated. A time difference Tij of zero means that the mowers are expected to be at the two points at the same time, whereas a large time difference Tij means that when the first mower is expected to be at its respective point Pi, the second mower will be a long time away from reaching its respective point Pj′, or will have already reached its respective point Pj′ a long time ago. In any case, a small time difference Tij is indicative of a higher likelihood of a potential collision or near-collision or hazard, whereas a large time difference Tij is indicative of a much smaller likelihood of same. Consequently it is prudent to use a value for Tthresh that is not too big (which would cause unnecessary delays) or too small (which would result in an unacceptably high risk of near-collisions). In some embodiments, Tthresh may be selected to be at least 5 seconds but no more than 60 seconds, or in a range from 10 to 40 seconds, or about 20 seconds. A comparison of the time difference Tij to the parameter Tthresh occurs in step 1303L.

If the time difference Tij is greater than Tthresh, operation proceeds from step 1303L through junction box 1303g to the j, i increment boxes 1303h, 1303i, and no hazard condition is declared. If however Tij is less than (or in some cases equal to) Tthresh, then operation proceeds from step 1303L to step 1303m, where the processor declares a hazard condition. From there, operation may proceed to steps 1203f, 1203g, 1203h described above in connection with FIG. 12.

The declaration of a hazard condition by a given autonomous mower does not necessarily mean that mower will modify its mowing operation in any way or take any type of evasive action, since that may depend further on a comparison of the priority codes of the respective mowers. The first and second (and third and fourth, etc.) autonomous mowers are preferably programmed with the same or substantially the same instruction sets and algorithms, as well as the same parameters Dthresh, Tthresh, etc., such that if a first mower declares a hazard condition based on its analysis of a first and second mow path timetable, a second mower analyzing the same timetables will also declare a hazard condition, and if the first mower designates itself “junior” and thus take evasive action, then the second mower will NOT designate itself “junior”, and may not take evasive action, and vice versa.

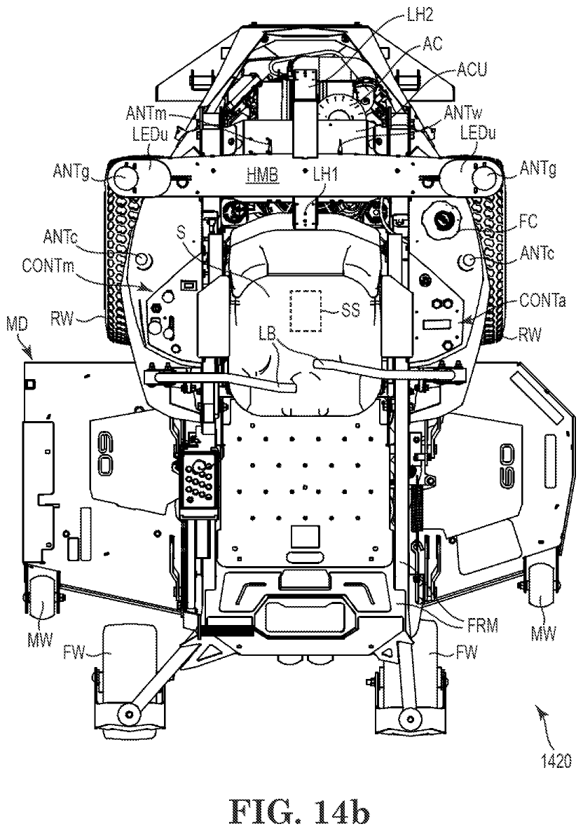

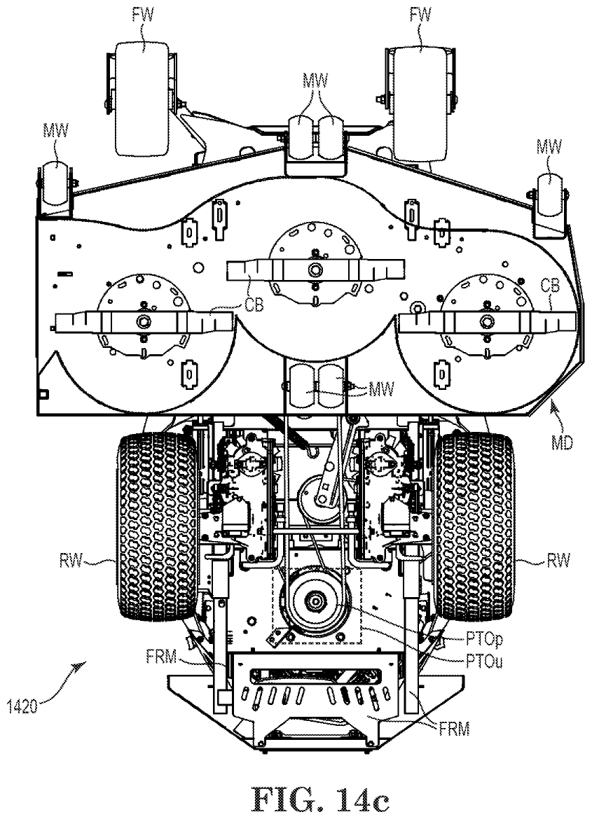

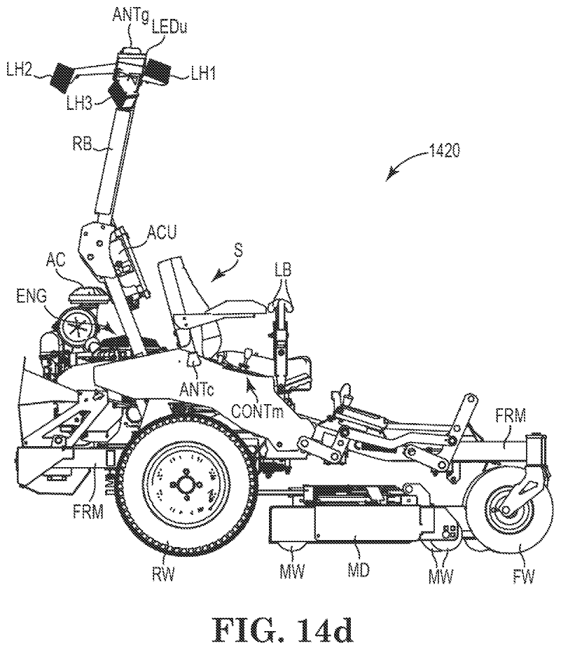

An example of a mowing machine capable of the autonomous operation described herein is shown from different viewing orientations in FIGS. 14a through 14d. FIG. 14a is a perspective view of such an autonomous mower 1420, and FIGS. 14b, 14c, 14d are top, bottom, and side views thereof respectively. The figures will be described collectively rather than individually, keeping in mind that like reference numerals designate like elements.

The autonomous mower 1420 may include otherwise conventional components and elements such as: a frame FRM; an engine ENG; front wheels FW and rear wheels RW; a mowing deck MD supported in part by minor wheels MW and having three rotary cutting blades CB (other numbers and configurations of cutting blades are also contemplated); an air cleaner AC; a power take-off (PTO) unit PTOu including a power take-off pulley PTOp, the PTO unit selectively coupling the engine to the mower deck MD and cutting blades CB; a fuel tank having a fuel cap FC; and a roll bar RB. These components can be incorporated into the mower, and can function and operate, in substantially the same way as in a conventional non-autonomous mower.

The reader may be surprised to see other components of the mower 1420 that might lead one to assume the mower is not autonomous. In particular, the mower 1420 also has: a seat S on which a human operator can sit, and a seat switch SS coupled thereto that detects whether a person is sitting on the seat S; manual controls CONTm a human operator can manipulate to control and manage the mower 1420; and a left and right lap bar LB the human operator can grasp and manipulate to drive and steer the mower manually. These components may be arranged and configured to allow the mower 1420 to be operated manually by the human operator as a conventional zero-turn rider mower. In alternative embodiments, the elements and features of the mower 1420 that are specific to manual operation, including the seat S, lap bars LB, and manual controls CONTm, may be omitted. However, by including such manual operation elements, the mower 1420 can provide enhanced value to the owner as a hybrid mower, being capable of either fully manual operation or fully autonomous operation.

The mower also has other components and elements that are more specifically dedicated to autonomous operation. These include: an autonomy control unit ACU, which may house an electronic controller 1426 and a memory unit 1427; autonomous controls CONTa; a LIght Detection And Ranging (LIDAR) detection system including one or more LIDAR detection heads LH1, LH2, LH3, LH4; a cellular transceiver for two-way communication with a conventional cellular telephone network, including one or more cellular antennas ANTc; a WIFI communication system and transceiver, including a WIFI antenna ANTw; a machine-to-machine (M2M) communication system and transceiver, including an antenna ANTm for such system; and a horizontal mounting bar HMB disposed atop the roll bar RB, on which can be mounted components such as one or more GNSS antennas ANTg for a GNSS detection system, and one or more visible light emitting units LEDu.

The autonomy control unit ACU may include a box or enclosure within which sensitive electronic components or systems may be housed, including at least the electronic controller 1426 and the memory unit 1427. The enclosure may include padding or the like for vibration isolation, and may comprise metal for at least some degree of EMI shielding. The ACU may be conveniently mounted behind the seat S, between two upward posts of the roll bar RB. The ACU may alternatively be mounted elsewhere on the mower 1420.

The electronic controller 1426 may be any suitable digital electronic controller or microcontroller, now known or later developed, that is capable of performing the tasks described herein in the hot, noisy, and high-vibration environment of an engine-powered mower. The controller 1426 may include one or more suitable central processing unit (CPU), system clock, dedicated read-only memory (ROM) and random access memory (RAM), and input/output modules, among other features and capabilities. The controller 1426 may be or include a single integrated circuit (IC) or circuit board, or it may include multiple such circuit boards and ICs. The controller 1426 electronically controls and/or communicates with other system components over wired connections, including one, some, or all of: the GNSS unit; the M2M transceiver; the WIFI transceiver; the cellular transceiver; the LIDAR detection unit(s); a drive system including for example electronic actuators coupled to the left and right mower wheels by hydraulic transmission units; the PTO unit PTOu; the light emitting units LEDu and/or other lights; an internal clock; the memory unit 1427; the autonomous controls CONTa; the seat switch SS; one or more displays; and various other devices, sensors, or components.

The separate memory unit 1427 may be or include non-volatile memory, and it may store instructions such as software and firmware which, when loaded into and carried out by the controller 1426, cause the controller and mower to perform the tasks described herein. The memory unit 1427 may also preferably store the parameters, constants, digital codes, and the like that are necessary or useful for carrying out the described operations. The reader will understand that an electronic engineer of ordinary skill can select the appropriate electronic components and configure them in such a way as to provide the controller 1426 and the autonomous mower 1420 with the functionality as described, without undue experimentation.

The autonomous controls CONTa may include one or more switches, keypads, displays, or the like that a human operator can use to set up, initialize, or authorize autonomous operation of the mower 1420. In a simple case, the controls CONTa may be or include a switch, connected to the controller 1426, to turn the autonomous function on or off, e.g., to select between autonomous operation and manual operation.

However, due to potential problems that could result from an autonomous mower being programmed or set into motion by untrained, unskilled, or even mischievous individuals, the mower 1420 may employ extra safeguards before it will allow itself to operate in an autonomous manner. One such safeguard may be to allow the autonomous function to be turned on only by authorized individuals, e.g., individuals who have undergone adequate training. The manufacturing company that makes and sells the autonomous mower 1420 may for example provide training sessions for users, and may maintain a database of individuals who have taken and passed the training session. The mower 1420 may then be configured to receive an authorization code from an authorized individual, and/or an authorization code directly from the manufacturer, and may be further configured to require such an authorization code before the mower allows itself to operate autonomously. The controls CONTa may be used by such trained individual to enter such an authorization code that the controller 1426 will then recognize and approve. Alternatively, the authorized individual may use a software application (“app”) on his or her smart phone or other mobile device to communicate with the mower 1420, or with the manufacturer. The initialization process may include two-factor authentication whereby, for example, the authorized individual verifies that they have permission to use the mower 1420 by providing it a cryptographically signed authorization from the manufacturer via the app, as well as verifying that they have the machine in their possession by inputting a one-time verification code generated by the controller 1426 and shown on the display (e.g. an LCD display) of the controls CONTa. After verifying the authorization and verification code is authentic, the controller may then enable the mower's automation feature.

In addition to or instead of a switch in the autonomous controls CONTa to select between autonomous and manual operation, the seat switch SS may also be used for this purpose, or may assist the operation of the separate switch on the control panel cluster. In a conventional riding mower, it is known to use the seat switch SS as a safety mechanism to turn the engine off when the seat switch indicates the driver is no longer sitting on the seat. In our hybrid mower, the seat switch SS may also connect to the electronic controller 1426, and the controller may be programmed to permit only autonomous operation when the seat switch is off (the seat is vacant) and to permit only manual operation when the seat switch is on (the seat is occupied).

The LIDAR detection system may be used by the mower 1420 to identify any fixed obstacles (e.g. trees, bushes, walls, etc.) or transient obstacles (e.g. children, dogs, cats, etc.) that are not already known to the mower through its mow path map(s) or other stored instructions. The LIDAR system operates on the basis of images it generates of the surrounding area from its LIDAR detection head(s), each such head having a certain limited field of view. The controller 1426 communicates with the LIDAR system and, upon detecting an unknown fixed or transient obstacle, can follow programmed instructions causing it to take appropriate evasive action using the mower's drive system and/or PTO unit PTOu. The LIDAR system for the mower 1420 has four LIDAR detection heads, one (LH1) that is pointed or directed to the front of the mower, one (LH2) that is pointed or directed to the rear of the mower, and two more (LH3 and LH4) that are pointed to the respective sides of the mower. The use of four such heads allows the controller 1426 to have a combined field of view (for the LIDAR system) that substantially surrounds the mower over substantially 360 degrees. Preferably, the front-directed head LH1 is pointed somewhat upwardly compared to the other LIDAR heads so that the frontward field of view extends farther out from the mower than the other views, thereby giving the controller 1426 more advanced warning of an unknown obstacle that is ahead of the mower when the mower is moving forward.

The mower may also include a cellular transceiver that provides two-way communication over a cellular communication band with a conventional cellular telephone network. The cellular transceiver includes one or more suitable antennas, such as the two cellular antennas ANTc shown in the figures. The cellular telephone network may in turn communicate with the global network of computer networks commonly known as the internet. Thus, the mower 1420 may receive wireless digital signals from, or send wireless digital signals to, any smart phone or other electronic device connected to the cellular phone network, and may likewise receive signals from or send signals to any device connected to the internet. This may allow the mower 1420 to communicate with authorized users using the app discussed above, and/or with the manufacturer, or database(s) or device(s) owned by the manufacturer, for purposes of authorization protocols as discussed above, or for other purposes.

The cellular transceiver may typically operate at an output power of about 3 watts over any of the reserved cellular frequency bands from 0.6 to 39 GHz, and may have a communication range of approximately 1-2 miles (or about 1.5 to 3 km).

The mower 1420 may also include a WIFI communication system and transceiver, including a WIFI antenna ANTw. The WIFI system may allow the mower to communicate with smart phone or similar mobile electronic devices independent of the cellular communication system. WIFI systems typically operate in the U.S. at an output power of about 100 milliwatts in a frequency band at or around 2.4, or 5, or 6 GHz, and may have a communication range of approximately 300 feet, or 100 feet (or about 100 meters or 30 meters).

The mower 1420 also preferably includes a machine-to-machine (M2M) communication system and transceiver, including an antenna ANTm for such system. The M2M communication system supports digital wireless communication directly between two mowers over a wireless data channel. This assumes, of course, that the two mowers are equipped with compatible M2M transceivers. The direct M2M communication is independent of other communication systems the mower may have, including the cellular communication system and the WIFI communication system.

The M2M communication system may typically operate at an output power of about 100 milliwatts at a frequency band at or around 2.4 GHZ, and may have a communication range of approximately 300 feet (or about 100 meters).

The mower 1420 also preferably includes a horizontal mounting bar HMB which may be disposed atop the roll bar RB as shown. This may serve as a foundation on which other components may be mounted, including one or more GNSS antennas ANTg for a GNSS detection system, and one or more visible light emitting units LEDu. The units LEDu preferably comprise bright, long-lasting, and rugged solid-state lighting elements such as light-emitting diodes (LED). Each unit LEDu may have or include LED lighting elements of only a single visible color, or LED elements of different colors such as red, yellow (amber), green, and/or blue. The visibility of the light emitting units LEDu is enhanced by being mounted high on the mounting bar HMB. The controller 1426 may activate the light emitting units LEDu in ways that are indicative of the status of the mower. For example, the units LEDu may emit a steady green light as the mower maneuvers along its assigned mow path and no obstacles or other potential hazards (including other mowers) are detected. The emitted light may change to yellow/amber when the controller 1426 has detected the presence of another autonomous mower. The emitted light may change to red when the controller declares a hazard condition and designates itself as junior such that it has paused its motion or otherwise taken evasive action.

Other uses of the light emitting units LEDu are also contemplated. For example, when two mowers have identified each other and have exchanged priority codes such that they have determined which mower is junior to the other, the LEDu units of the mowers can emit light of different colors, e.g., yellow for the junior mower and green for the senior or non-junior mower, or other combinations if more than two mowers are involved. These color designations can be transmitted by the mowers to an authorized individual's smart phone or other mobile device so that the software application (“app”) identifies the mowers conveniently by their respective color designations.

The GNSS system (such as a GPS unit or the like) has been discussed above but will be summarized again here for convenience. The GNSS system uses antennas ANTg that receive signals from orbiting satellites to determine therefrom the position or location of the antennas with great precision anywhere of interest on the surface of the Earth. The GNSS system uses the received signals to calculate the location of the antennas, and expresses the location as an (x,y) coordinate, where x is the longitude of the point and y is the latitude of the point. Other suitable coordinate units can also be used. The received signals can also provide very accurate time information. We have found it advantageous to use two GNSS antennas ANTg, and to separate them from each other and from other system antennas to the extent feasible. Thus, the depicted antennas ANTg are mounted on opposite ends of the horizontal mounting bar HMB, and the mounting bar is spaced substantially apart from the other system antennas ANTm, ANTw, and ANTc.

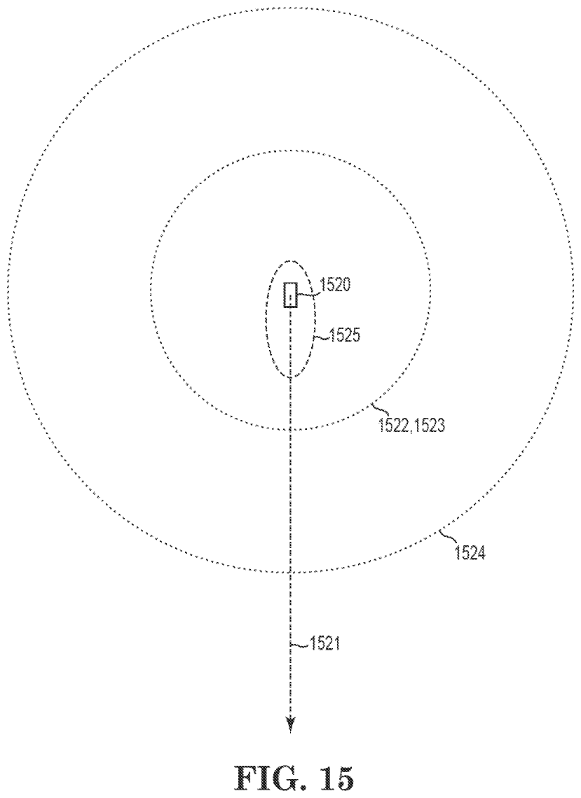

A bird's-eye view of an autonomous mower 1520 traveling along a programmed mow path in a direction 1521 is shown in FIG. 15 to give the reader a rough sense of some typical ranges or limits of some of the communication systems or detection systems discussed herein, with the caveat that the figure is not drawn to scale. Boundary 1525 is closest to the mower 1520, and represents a typical or possible limit to the LIDAR detection system. The boundary 1525 is drawn as an oval and assumes that multiple LIDAR heads are used to encompass all directions around the mower, and further assumes that at least one LIDAR head is forward-looking and directed in a manner that detects objects farther away than do LIDAR heads looking in other directions. Boundaries 1522 and 1523 are farther out from the mower 1520 than boundary 1525, and represent the communication limits of the M2M communication system and the WIFI communication system, respectively. The figure shows these two limits as substantially overlapping or coinciding with each other, which can occur depending on which components are selected. The boundary 1524 is farther out from the mower than the boundaries 1522, 1523, and represents the communication limit of the cellular communication system of the mower 1520. If the figure were to scale, the boundary 1524 would be off the edge of the paper since its radius would typically be at least ten times the radius of the boundaries 1522, 1523.

Not shown in FIG. 15 is the detection limit of the GNSS system for the mower 1520. This limit of course is far beyond even the boundary 1524, since signals for this system are transmitted from orbiting satellites to the GNSS antennas, such satellites located thousands of miles (thousands of kilometers) above the Earth's surface.

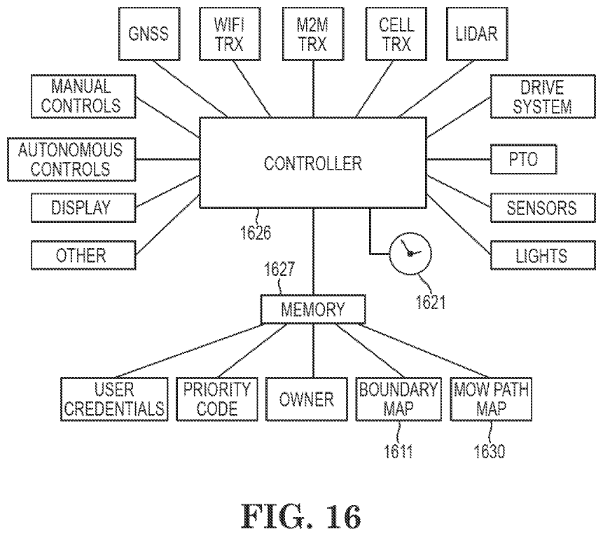

A schematic block diagram of components and systems that may be included in an autonomous mower, and their interrelationships, is shown in FIG. 16. In that figure, the controller 1626 and the memory 1627 may be the same as or similar to electronic controllers and memory units discussed elsewhere herein, the descriptions of which will therefore not be repeated. The controller 1626 controls or communicates with various communication or sensing systems, such as: a GNSS system; a WIFI transceiver (WIFI TRX); a machine-to-machine transceiver (M2M TRX); a cellular transceiver (CELL TRX); and a LIDAR system. These too have been described above. The controller 1626 also communicates with and directs the drive system (DRIVE SYSTEM) for the mower, which selectively channels mechanical power from the engine to the left or right wheels to thereby maneuver the mower as desired forward, backward, or along any type of forward or backward turn, and with the PTO, which selectively channels mechanical power from the engine to the cutting blades in the mower deck and optionally to other mechanical systems. The controller 1626 can also communicate with lights such as those of the light-emitting units LEDu, and sensors such as engine diagnostic sensors or other type of analog or digital sensor. The controller can also include or communicate with a system clock 1621. If desired, the system clock may be synchronized or adjusted as needed with timing information received from the GNSS system.

The controller 1626 also communicates with autonomous controls (AUTONOMOUS CONTROLS) that may be provided on the mower, such as the controls CONTa described above, as well as with any manual controls (MANUAL CONTROLS) such as the controls CONTm described above if the mower is configured as a hybrid manual/autonomous unit. A display (DISPLAY) may be provided as part of the autonomous controls or otherwise in order to communicate messages, commands, or instructions to the user. The controller 1626 may also communicate with, direct, or detect other components, systems, and devices (OTHER).

Importantly, the controller 1626 also communicates with memory unit 1627, both with regard to reading information from the unit 1627 and writing or storing information to the unit 1627. The memory unit 1627 may include or contain any instructions, codes, data, data packets, databases, or the like that may be necessary or useful for carrying out the described functions and tasks. The memory unit 1627 may include user credential information (USER CREDENTIALS), e.g. for the purpose of authorizing a given person to operate the mower autonomously. The memory unit may also include a priority code or other digital code (PRIORITY CODE), e.g. for the purpose of determining whether a given mower is to take evasive actions. The memory unit may also include owner information (OWNER), e.g., the identity of the owner of the mower, which may also be used for the purpose of authorizing a given person to operate the mower autonomously (a given owner may designate only a limited set of authorized persons). The memory unit may also include one or more boundary maps (BOUNDARY MAP) which the controller can use to ensure the mower does not stray outside of the defined mowing region. The memory unit may also of course include one or more mow path maps, timed mow path maps, and mow path timetables (MOW PATH MAP), whose purposes the reader will understand well in view of the lengthy discussions above.

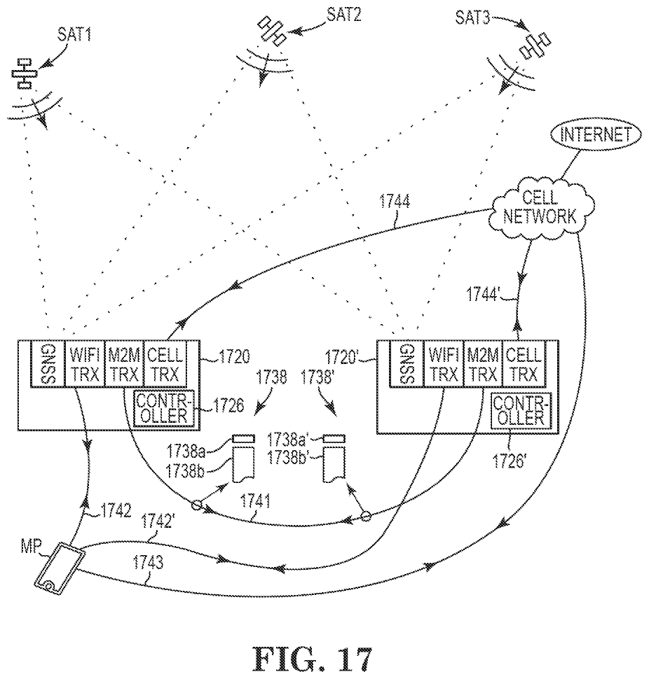

A schematic representation of two autonomous mowers in communication with each other and in communication with other elements of a working autonomous mowing system is provided in FIG. 17. A first autonomous mower 1720 and a second autonomous mower 1720′ are assumed to be carrying out their respective mowing tasks, and are physically close enough that their M2M systems are in communication with each other. Each mower 1720, 1720′ includes a GNSS system (GNSS), a WIFI transceiver (WIFI TRX), a M2M transceiver (M2M TRX), a cellular transceiver (CELL TRX), and a controller 1727, 1726′ (CONTROLLER) respectively. Each mower is aware of its own precise location by virtue of signals received by its GNSS detectors from GNSS satellites SAT1, SAT2, SAT3. Mower 1720 can communicate directly with an authorized user's mobile wireless device such as a mobile phone MP over a WIFI channel 1742, and mower 1720′ can similarly communicate with the mobile phone MP over the same or similar WIFI channel 1742′. The mowers can also communicate with the mobile phone MP indirectly through the cellular network (CELLULAR NETWORK) over communication channels 1744, 1744′, and 1743 as shown. which cellular network may additionally be connected to the internet (INTERNET), and from there to a manufacturer's database or web site.

The M2M systems of the mowers are in direct communication with each other over communication channel 1741. Navigational information of the mowers is exchanged over that channel 1741 so that each mower is aware not only of the other mower's presence but also of its current location, current heading, and planned mow path (and timetable) for at least then next few seconds. The mower 1720 wirelessly transmits or broadcasts via its M2M transceiver a data packet 1738 which may include one or more items of digitally encoded information 1738a, 1738b, such as a priority code or other digital code (1738a) and a mow path map, timed mow path map, and/or mow path timetable (1738b), as well as other information. The mower 1720′ likewise wirelessly transmits or broadcasts via its M2M transceiver a data packet 1738′ which may include one or more items of digitally encoded information 1738a′, 1738b′, such as a priority code or other digital code (1738a′) and a mow path map, timed mow path map, and/or mow path timetable (1738b′), as well as other information.

Unless otherwise indicated, all numbers expressing quantities, measured properties, and so forth used in the specification and claims are to be understood as being modified by the term “about”. Accordingly, unless indicated to the contrary, the numerical parameters set forth in the specification and claims are approximations that can vary depending on the desired properties sought to be obtained by those skilled in the art utilizing the teachings of the present application. Not to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, to the extent any numerical values are set forth in specific examples described herein, they are reported as precisely as reasonably possible. Any numerical value, however, may well contain errors associated with testing or measurement limitations.

The use of relational terms such as “top”, “bottom”, “upper”, “lower”, “above”, “below”, and the like to describe various embodiments are merely used for convenience to facilitate the description of some embodiments herein. Notwithstanding the use of such terms, the present disclosure should not be interpreted as being limited to any particular orientation or relative position, but rather should be understood to encompass embodiments having any orientations and relative positions, in addition to those described above.

Various modifications and alterations of this invention will be apparent to those skilled in the art without departing from the spirit and scope of this invention, which is not limited to the illustrative embodiments set forth herein. The reader should assume that features of one disclosed embodiment can also be applied to all other disclosed embodiments unless otherwise indicated. All U.S. patents, patent application publications, and other patent and non-patent documents referred to herein are incorporated by reference, to the extent they do not contradict the foregoing disclosure.

What is claimed is:

1. A method of operating a first autonomous mower, comprising:
providing the first mower with a drive system, a controller, a memory unit, and a wireless transceiver;
storing a first mow path map and a first priority code in the memory unit;
maneuvering the first mower, using the drive system under control of the controller, along a first mow path in accordance with the first mow path map;
generating a first mow path timetable from the first mow path map to indicate when the first mower will be at different points along the first mow path map;
transmitting from the transceiver a first data packet that includes the first mow path timetable and the first priority code;
monitoring for the presence of a second mower during the maneuvering; and
in the event of the second mower being present:
receiving from the second mower, via the transceiver, a second data packet that includes a second mow path timetable and a second priority code;
determining, using the first and second mow path timetables, whether a hazard condition exists;
comparing the first priority code to the second priority code; and
upon determining that the hazard condition exists, determining whether to modify the maneuvering as a result of the comparing.

2. The method of claim 1, wherein determining whether a hazard condition exists includes calculating separation distances using the first and second mow path timetables.

3. The method of claim 2, wherein determining whether a hazard condition exists further includes comparing the calculated separation distances to a first separation threshold.

4. The method of claim 1, wherein the result of the comparing is to designate the first mower with one of a junior status or a senior status, and the determining whether to modify the maneuvering yields a determination to modify the maneuvering only if the first mower designation is the junior status.

5. The method of claim 1, wherein the method further includes, upon the determination to modify the maneuvering, changing a speed of the first mower.

6. The method of claim 5, wherein changing the speed of the first mower includes pausing movement of the first mower along the first mow path.

7. The method of claim 1, wherein the transmitting is carried out on a periodic basis during the maneuvering and before receiving the second data packet.

8. The method of claim 7, further including updating the first mow path timetable that is included in the periodically transmitted first data packet.

9. The method of claim 1, further comprising:
determining a location of the first mower using a global navigation satellite system (GNSS).

10. A method of operating an autonomous mower, comprising:
providing the mower with a drive system, a memory unit, a wireless transceiver, and a controller coupled to the drive system, the memory unit, and the transceiver;
storing a first mow path map in the memory unit;
maneuvering the mower autonomously with the controller along a first mow path in accordance with the first mow path map;
using the controller during the maneuvering to monitor for a second mower by monitoring for a second data packet received from the transceiver; and
upon receipt of the second data packet, using the controller to analyze the second data packet, the second data packet including a second mow path map that the second mower is traveling along.

11. The method of claim 10, further comprising:
using the controller to compare the first mow path map to the second mow path map, and to determine whether to modify the maneuvering as a result of the comparison.

12. The method of claim 10, wherein the storing also includes storing a first digital code in the memory unit, and the second data packet also includes a second digital code, the method further comprising:
using the controller to compare the first digital code to the second digital code, and to determine whether to modify the maneuvering as a result of the comparison.

13. The method of claim 10, wherein the controller is configured to generate a first mow path timetable from the first mow path map, and wherein the second data packet includes a second mow path timetable for the second mower, and wherein the analysis by the controller includes comparing the first mow path timetable to the second mow path timetable.

14. The method of claim 10, wherein the providing also includes providing the mower with a GNSS device that communicates with a global navigation satellite system (GNSS), and the controller couples to the GNSS device to provide a current location of the mower.

15. A method of operating an autonomous mower, comprising:
providing the mower with a drive system, a memory unit, a wireless transceiver, and a controller that couples to the drive system, the memory unit, and the transceiver;
storing a first mow path map in the memory unit;
maneuvering the mower autonomously with the controller along a first mow path in accordance with the first mow path map; and
during the maneuvering:
using the controller to generate a first mow path timetable from the first mow path map;
transmitting from the transceiver a first data packet that includes a substantial portion of the first mow path map timetable; and
using the controller to monitor for a second mower by monitoring for a second data packet received from the transceiver.

16. The method of claim 15, wherein the storing also includes storing a first digital priority code in the memory unit, and the first data packet further includes the first digital priority code.

17. The method of claim 16, wherein, upon receipt of the second data packet, using the controller to analyze the second data packet, the second data packet including a second digital priority code, and to determine whether to modify the maneuvering as a result of the analysis.

18. The method of claim 17, wherein the first digital priority code is a product serial number unique to the mower, and the second digital priority code is a product serial number unique to the second mower.

19. An autonomous mower, comprising:
mower blades, and a power takeoff (PTO) unit coupled to the mower blades;
a drive system, a memory unit, and a wireless transceiver, the memory unit having stored therein a first mow path map and a first digital code; and
a controller coupled to the PTO unit, the drive system, the memory unit, and the transceiver, and configured to maneuver the mower along a first mow path in accordance with the first mow path map;
wherein the controller is configured to generate a first mow path timetable from the first mow path map to indicate when the mower will be at different points along the first mow path map;
wherein the controller is further configured to transmit from the transceiver a first data packet that includes the first mow path timetable and the first digital code;
wherein the controller is further configured to monitor for the presence of a second mower while maneuvering the first mower along the first mow path; and
wherein the controller is further configured to receive a second data packet from the second mower, and to make a determination of whether to modify the maneuvering based on a comparison of the second data packet with the first mow path timetable and the first digital code.

20. The mower of claim 19, further comprising:
a seat, and one or more control levers coupled to the drive system, for use by a user; and
a switch configured to select between autonomous operation of the mower by the controller and manual operation of the mower by the user.
